(19) United States
(12) Patent Application Publication
(10) Pub. No.: US 2022/0382059 A1
(43) Pub. Date: Dec. 1, 2022

(54) COUPLING FEATURE FOR DATA GLASSES FOR COUPLING AMBIENT LIGHT INTO AN AMBIENT LIGHT SENSOR LOCATED INSIDE THE SPECTACLE FRAME

(71) Applicant: tooz technologies GmbH, Aalen (DE)

(72) Inventor: Marko Sarasmo, Haukipudas (FI)

(21) Appl. No.: 17/752,632

(22) Filed: May 24, 2022

(30) Foreign Application Priority Data
May 27, 2021 (DE) 10 2021 205 393.9

(51) Int. Cl. G02B 27/01

(52) U.S. Cl. CPC G02B 27/0172; G02B 2027/0178

(57) ABSTRACT

The disclosure relates to a head-mounted-display and a sensor included in a fixation component of the head-mounted-display, wherein the sensor is configured for the detection of ambient light, wherein the display element has a coupling feature configured for a direction of ambient light impinging on the coupling feature onto the sensor.

### CROSS REFERENCE TO RELATED APPLICATION

This application claims priority of German patent application no. 10 2021 205 393.9, filed May 27, 2021, the entire content of which is incorporated herein by reference.

### TECHNICAL FIELD

The disclosure relates to a head-mounted-display and a sensor comprised in a fixation component of the head-mounted-display, wherein the sensor is configured for the detection of ambient light, wherein the display element comprises a coupling feature configured for a direction of ambient light impinging on the coupling feature onto the sensor.

### BACKGROUND

An ambient light sensor is a used, for example, in smartphones, notebooks and other mobile devices. It is used to detect the amount of ambient light present. This information can be used to dim the device's display in order to be well adapted to the present amount of ambient light. Like this it can, for example, be avoided having the display too bright when the user's pupils are adapted for vision in darkness, or similarly too dim the display when the device is used outdoors in the daytime. This serves also for saving resources. For example, the lifetime of a battery can be prolonged.

One typical international unit for the illuminance of ambient light is preferably the lux. The standard performance of an ambient light sensor spans advantageously from less 50 lux or less to more than 10,000. The sensor is preferably capable to detect the illuminance over such a wide range. Common types of ambient light sensors can comprise phototransistors, photodiodes, and/or photonic integrated circuits, which preferably integrate a photodetector and an amplifier in one device.

This functionality is particularly important for head-mounted-displays (HMDs), since the typical display of a head-mounted display is transparent and overlaps the displayed data with the environment in the line of sight of the user. The correct functioning of the ambient light sensor (ALS) is thus of uttermost importance for HMDs. At the same time, consumers whish that HMDs, in particular data glasses, augmented reality glasses and/or smart glasses should feature a subtle appearance with little to no difference in the appearance to traditional glasses. All known ALS for HMDs are mounted at an outer surface of the HMD, where they are clearly visible, especially when the HMD features a color which is very different than the color of the ALS. To mount the ALS at an outer surface of the HMD is the only known way to couple the ambient light in a sufficient amount into the ALS. A further disadvantage of such an ALS is that it repeatedly gets dirty and has to be cleaned in order to function well.

Some existing devices are using separate lightguides or optical windows to cover ambient light sensor. Existing solutions include an optically transparent window or just a hole for an optical sensor. To reach a high quality HMD experience without any extra holes et cetera, the ambient light sensor and the light hole for it should be hidden. Also, while ALS are generally quite sensitive for light, the problem of the state of the art is that the ALS sensors are only sensitive to light coming from one particular direction with respect to the sensor. However, for most applications, it is desirable to measure the ambient light not only from a particular direction but to gather light from “all around”, which corresponds more to the definition of “ambient” light in a strict sense.

### SUMMARY

It is an object of the disclosure is to provide an HMD with an ALS, which does not have the disadvantages of the state of the art. It is in particular an objective of the disclosure to provide an HMD with a functioning ALS, which is not easily seen from the outside, which is efficient, enhances the aesthetics of the HMD, is more robust, requires low maintenance and is at the same time practical as well as easy to realize and cheap.

The aforementioned objective can, for example, achieved via a head-mounted-display, which includes a fixation component configured for an at least temporal fixation of the device to the head of a user, a generally transparent display element configured for an overlay of a visual data output with an environment in a field of view of the user and a sensor comprised in the fixation component configured for the detection of ambient light. The display element comprises a coupling feature configured for a direction of ambient light impinging on the coupling feature onto the sensor.

The following is an example in order to illustrate the head-mounted display as described by a particular embodiment:

The head-mounted display in this example is a pair of smart-glasses with see-through lenses functioning at the same time as display at least partially, with a projector projecting light comprising the information to be displayed onto the lenses. The device comprises an ALS which is integrated in the spectacle frame (which is an embodiment of the fixation component) and which is not visible from the exterior. At the lateral edge (preferably the lateral area) of the lens, there is an opening in the spectacle frame at a location close to the ALS. This opening comprises a light guide from the lateral edge to the ALS, allowing light from the edge to be directed to the sensor. The display comprises a coupling feature, for example, a small reflective element such as a small mirror. It is located, for example, at the lateral edge of the lens, at a location opposed to the location of the opening. The mirror is oriented such, that a significant amount of ambient light, for example, coming from a direction perpendicular to the lenses (from a direction within the field of view of a user of the smart-glasses), is directed onto the opening. This light can therefore be guided to the detector which thus can efficiently function without being seen from the exterior.

A head-mounted display is preferably a technical device which can be carried at the head of user and in particular close to the eyes of a user. It can preferably feature a technical device with a dedicated functionality for the user, as, for example, the display of data, the collection and/or processing of data. The head-mounted-display (HMD) comprises in particular so-called data-glasses. Preferably, the HMD comprises a visual data output in form of a display element.

A fixation component configured for an at least temporal fixation of the device to the head of a user can preferably comprise a support frame, for example, a spectacle frame. An at least temporary fixation of the system to a user's body is preferably to be understood in this context. For example, data glasses are put on by a user to be worn and taken off again if necessary. Typically, temples of a spectacle frame are placed behind the ears in a suitable way. This corresponds preferably to an example of a temporary fixation of the system to a body. A fixation component is especially configured for an at least temporary frictional connection and/or positive connection of the HMD to the head of the user.

A generally transparent display element, which is configured for an overlay of a visual data output with an environment in a field of view of the user preferably features a transparency with respect to visible light which is such that the user is capable to see the environment in his field with essentially no limitations. Preferably, the display element is at least 50% transparent for visible light within a wavelength of 380 nm to 780 nm, more preferably at least 60% transparent, even more preferably at least 70% transparent, in a further preferred embodiment at least 80% transparent, in a further, even more preferred embodiment at least 90% transparent and in a most preferred embodiment at least 95% transparent.

The visual data output can, for example, be a generated by a projector for projecting data on the transparent display element, which may be comprised, for example, in transparent glasses of the HMD, which are positioned in front of the eyes of a user of the HMD when it is worn. Alternatively, there may also be suitable structures in the transparent display element which cause light to be conducted in the transparent display element from a suitable light source and/or an appropriate outcoupling of the light in the direction of the eye, so that the viewer is provided with a visual data output while the display element is transparent.

The transparent display element may have the dimensions and appearance of normal spectacle lenses or be comprised in elements which such dimensions and appearances. They can, for example, resemble regular lenses of glasses.

The sensor is comprised in the fixation component and configured for the detection of ambient light. A sensor configured for the detection of ambient light will be preferably also referred to as an ambient light sensor (ALS) within this document. Typical sensors as well as general requirements on the sensors have been introduced previously in the background section. An example of a suitable sensor is the model OPT3002 light-to-digital sensor by Texas Instruments. An ALS can, for example, feature a spectral bandwidth ranging from 300 nm to 1000 nm, with measurable intensity levels in the range of 1 nW/cm² to 10 mW/cm². A typical sensor size can be in the order of mm², for example, 2×2 mm. The area of the detection area can be in the order of 0.1 mm² to 1 mm², for example, 0.49×0.39 mm.

Preferably, the sensor is comprised at the inside of the fixation component. At the inside of the fixation component preferably means that there is no direct contact of the sensor with the surface and/or the surrounding of the fixation component. Preferably, the sensor comprises at least one detection surface. It is particularly preferred that the detection surface has no direct contact with the surface and/or the surrounding of the fixation component. The ambient light impinging on the detector, in particular on the detection surface, preferably comes from the display element, in particular the coupling feature. Therefore, there can exist some “optical connection” between the sensor, preferably the detection surface, and the display element, in particular the coupling feature, so that the ambient light can be detected. This “optical connection” can, for example, be a hole and/or a light guiding structure in the fixation component at the contact surface with the display element. The detector is preferably synonym to the sensor.

The sensor is preferably at least one sensor. Of course, there can be more than one sensor comprised.

The display element comprises a coupling feature configured for a direction of ambient light impinging on the coupling feature onto the sensor. The coupling feature can, for example, comprise a reflective element configured for directing ambient light from the surrounding onto the sensor. Therefore, the coupling feature can, for example, be dimensioned and/or oriented such that a sufficient amount of ambient light impinging on the display element can be detected for the ALS to function according to its functionality. The same can, for example, be said about the reflectivity of the coupling feature.

It is particularly preferred that the coupling feature does not significantly affect neither the functionality of the transparent display element to display data nor the view on the environment in a field of view of the user due to its transparency. Therefore, the coupling feature is preferably positioned outside the field of view of the user, in particular at a lateral edge region of the display element. Alternatively, or additionally, the coupling feature can be transparent at least partially. Transparent can, for example, mean that light in the visible spectrum for humans impinging on the coupling feature from the environmental side is transmitted to the user side by preferably at least 50%, more preferably at least 60%, even more preferably at least 70% and in particular at least 80%. All relative values are preferably with regard to the intensity of the light. Alternatively, or additionally, the coupling feature is small enough that the functionality of the transparent display element is not affected. Small enough in this context preferably means that the coupling feature covers an area visible for the user with respect to the complete area of the display element and/or the transparent glasses/lenses of the HMD of less than 10%, more preferably less than 7%, even more preferably less than 5% and in particular less than 3%. The area of the coupling feature which is visible for the user preferably describes the cross-sectional area visible to the user when wearing the HMD.

The coupling feature is preferably at least one coupling feature. Several coupling features, for example, 1, 2, 3, 4, 5, 6, 7, 8, 9, 10, . . . , 15, . . . 20 or even more coupling features can be comprised. The more coupling features, preferably the higher the light coupling.

A single coupling feature can have the size in the order mm² up to multiple mm².

It can be preferred that the coupling feature is situated in the proximity of the ambient light sensor, for example, within a distance of 20 mm or smaller, preferably within a distance of 15 mm or smaller, more preferably within a distance of 10 mm or smaller, even more preferably within a distance of 5 mm or smaller and in particular within a distance of 2 mm or smaller with respect to the ALS.

The coupling feature can be situated within the display element and/or at an external surface of the display element.

The coupling feature preferably directs light from different directions onto the sensor and not only from one particular direction. Preferably, light coming from a large solid angle is directed onto the sensor in an amount large enough to be measured by the sensor. The solid angle can preferably be 0,3 Steradian or bigger, more preferably 0,6 Steradian or bigger, even more preferably 1.8 Steradian or bigger and most preferably 2π Steradian or bigger.

It can however also be preferred that the coupling feature directs light only coming from a particular direction onto the sensor, for example, light coming from the front side of the HMD. This can be advantageous for some applications.

Preferably, the coupling feature is configured in order to direct a sufficient amount of ambient light with a given intensity on the detector surface of the sensor such that the sensor can reliably measure and/or detect the so-directed light. Therefore, the coupling feature preferably features optical properties in order to direct and/or focus the light accordingly.

The head mounted display can thus be controlled, for example, its brightness, by an ALS which is not visible externally and at the same time fully functional. The ALS is at the same time more robust with respect to external influences due to its protected arrangement within the fixation component and does not need to be cleaned regularly.

In an embodiment of the disclosure, the ambient light directed onto the sensor is guided in the display element, in particular due to internal reflection. This can be in particular realized with a coupling feature configured for a direction of ambient light impinging on the coupling feature onto the sensor by directing it through the display element towards the sensor and/or the “optical connection” by an angle that enables total internal reflection of the light between two preferably at least essentially parallel boundary surfaces of the display element. The boundary surfaces can, for example, be the areal surfaces of the display element. The skilled person knows how to realize total internal reflection and knows that the required angles of the light to be reflected can, for example, be calculated by the formula arcsine(n₂/n₁), where n₁ is the refractive angle of the light guiding material and n₂ is the refractive index of the surrounding material. If the display element comprises, for example, glass with a refractive index of 1.5, total internal reflection would , for example, take place at an angle of about 46.5° or greater between the light and the normal to the boundary surface of the display element with the surrounding air.

This embodiment enables to direct sufficient light intensities to the sensor over larger distances and helps to realize an efficient sensor by directing a sufficient amount of light without significant loss to the sensor. At the same time, due to the efficient light guiding mechanism, there is a higher flexibility for the location of the coupling feature within the display element. It can, for example, be situated at a location where it does not affect significantly the field of view of the user.

In an embodiment of the disclosure the coupling feature is configured for the direction of ambient light impinging on the coupling feature onto the sensor by diffusion, reflection, preferably specular reflection, refraction and/or diffraction.

The skilled person knows how to realize the different direction mechanisms by the coupling feature. Reflection can, for example, be realized by a coupling feature which comprises a reflective element. Refraction can in particular be realized by a coupling feature comprising a refractive element, for example, a holographic optical element (HOE). Different direction mechanisms can also be combined within the coupling feature.

Diffusion or diffuse reflection is, for example, caused by light which strikes the surface of a (non-metallic) material and then bounces off in all directions due to multiple reflections. These can, for example, be caused by the microscopic irregularities inside the material or its surface. An example of a material which reflects diffusively is one with a rough surface. A rough surface is preferably called a matt surface. Diffusion can, for example, be described by Lambertian reflectance, in which the light is reflected with equal luminance (in photometry) or radiance (in radiometry) in all directions, as defined by Lambert's cosine law.

A reflective element can in particularly be partly reflective, such that a sufficient amount of light, for example, 30% or more, preferably 40% or more and in particular 50% or more of the light impinging on the coupling feature within the field of view of a user can be transmitted to the user such that his view is not affected too much.

A refractive element can in particularly be partly refractive, such that a sufficient amount of light, for example, 30% or more, preferably 40% or more and in particular 50% or more of the light impinging on the coupling feature within the field of view of a user can be transmitted to the user such that his view is not affected too much.

A reflective and/or diffractive element can in particular be reflective and/or diffractive in a wavelength selective manner, such that only a limited wavelength range is reflected and/or diffracted. Preferably, this wavelength range can be selected such that it is typically comprised in the spectrum of the ambient light and that the ALS is particularly sensitive to it. Like this, the ALS functions efficiently without distracting significantly the view of the user.

In particular, the wavelength range can be selected such that it would be typically comprised in the spectrum of ambient light and at the same time such that it is not or only partly visible to the eye of the user. A preferred example would be the selection of a wavelength range in the near infrared, in particular in a wavelength range above 780 nm. The coupling feature could thus be nearly transparent to the user. At the same time, efficient detectors for the ALS are available in the near infrared range.

In a further embodiment of the disclosure the display element is an areal display element comprising a lateral surface.

Areal preferably means that the display element has a large extension within a plane (which does not need to be flat, it can, for example, be curved) and an extension which is small in comparison in a perpendicular dimension. The lateral surface (there can be more than one lateral surface) is preferably the surface of the areal display element extending along the small extension. The preferably parallel surfaces which extend along the areal extension are preferably the areal surfaces.

If the display element is, for example, included within the eyeglass or spectacle “lenses” of data glasses, the areal surfaces would, for example, be the surfaces the user sees through, thus the visible front side and back side of the lenses, whereas the lateral surface would be the surface which is in direct contact with the spectacle frame.

In a further embodiment of the disclosure, the display element comprises a marking, in particular a logo, wherein the coupling feature is comprised in the marking. Through this, a very effective coupling feature can be realized without compromising the aesthetics of the head mounted display. The coupling feature can thus be a refractive or reflective element. Because the coupling feature is effective in coupling the light onto the sensor at least partly, it is visible clearly from the outside. Since it is formed as a marking, for example, a logo, this is however not problematic. Since most manufacturers want to place their logo on the glasses anyway, the logo can in this can be used for the ALS and has a practical dual function.

In a further embodiment of the disclosure, the marking is comprised on at least one areal surface of the areal display. When the marking is comprised in the areal surface, it is visible and at the same time very effective as a coupling feature.

In a further embodiment of the disclosure, the coupling feature is comprised in the lateral surface. A coupling feature comprised in the lateral surface is not distracting the field of view of the user and can be placed such that it is in close proximity to the ALS.

In a further embodiment of the disclosure, the lateral surface features a matt surface. A matt surface preferably is a surface with a diffuse reflection as opposed to a specular reflection. A matt surface can advantageously contribute to an even distribution of ambient light. This evenly distributed (reflected) light is preferably coupled in the (areal) display element (for example, the lens) and guided at least partially by total internal reflection. This light can at least partially be guided to the ALS if the direction of the light is fitting. It is therefore preferred that in combination with this feature, the angle of acceptance of the ALS is adapted accordingly by the provision of appropriate optical elements, for example, an optical lens, et cetera.

The amount of light coupled to the ALS is preferably proportional to the amount of light which is coupled in and/or guided by the display element. A matt surface increases the amount of light coupled in the display element by evenly distributing the light impinging on the lateral surface. A reflective surface can, for example, only couple light in the display element which hits the lateral surface at angles which are small with respect to the normal of the lateral surface. All other angles are reflected out of the display element after impinging on the lateral surface. Only a light featuring a direct light path to the sensor component could be detected. A matt surface can however also reflect larger angles into the display element and eventually onto the sensor. Also, multiple reflections at the matt surface can occur until the light is eventually reflected onto the sensor. Thus, by making the lens edges diffuse/matt, coupling to the lens is increased and angle of ambient light coupling angle is wider. Therefore, by a matt lateral surface, the ALS can operate more effectively.

In a further embodiment of the disclosure, the fixation component comprises a detection opening at a contact surface of the fixation component with the lateral surface of the display element configured for enabling an optical connection between the coupling feature and the sensor. Like this, the sensor can be located inside the fixation component. The detection opening can preferably be configured such that an angle of acceptance of light directed onto the sensor is large enough in order for the sensor to function properly.

Preferably, the detection opening is large enough in order that a sufficient amount of light directed from the coupling feature onto the sensor can reach the sensor, such that, with a given amount of ambient light, the so-directed light can be measured and/or detected by the sensor.

It is furthermore preferred that the detection opening is dimensioned and/or situated such with respect to the coupling feature and/or the sensor that the light directed from the coupling feature onto the sensor can reach the sensor without significant losses. This is particularly useful if the detection opening does not comprise a light guiding structure which can direct light also along a path which is not a straight line.

In a further embodiment of the disclosure, the fixation component comprises a bright and/or reflective surface, preferably a white surface, in particular at a region of the contact surface with the lateral surface of the display element.

A bright surface is in particular a surface which does not absorb large amounts of the visible light which hits the surface. Preferably, the darker the color of the surface, the more light is absorbed by it. A particular example of a bright surface would be a white surface. Such a bright surface can help redirect the light into the display element and onto the sensor. Thus, in particular in combination with a matt or a smooth (for example, specular reflective) lateral surface of the display element which is partly transparent, the light which traverses the display element can be reflected again by the reflective/bright spectacle frame. This reflected light can the again be transmitted by the lateral surface and coupled into the display, where it is guided. As stated above, such guided light can then eventually be directed onto the sensor.

It is preferred that this embodiment includes a smooth lateral surface which is transparent. This lateral surface is reflective/transparent depending on the angle of incidence of the light onto it. Therefore, light, which is not reflected, is transmitted and can be reflected back by the fixation component as described above. This light can then be coupled onto the sensor.

In a further embodiment of the disclosure, the fixation component comprises a non-absorbing surface, preferably a white surface, wherein the fixation component is at least partially diffusive. Like this, the light is not absorbed by the spectacle frame and is then distributed evenly due to the diffusiveness of the spectacle frame. In particular in combination with a lateral surface which is transparent, in particular a smooth lateral surface, some of this light can then be coupled into the display element and onto the sensor, increasing the relative amount of light coupled onto the sensor and therefore the sensor's effectiveness.

It can be particularly preferred that more than one coupling different coupling features are included. For example, the embodiments comprising a lateral surface and/or a fixation component as described above can be combined with a further coupling feature, for example, a diffractive element, comprised within the display. Like this, the overall efficiency of the sensor can be increased further.

In a further embodiment of the disclosure, the detection opening includes a light guiding structure configured for guiding light from the lateral surface to the sensor. A light guiding structure can be a structure which is transparent for the light to be guided, while at the same featuring a structure with respect to its geometrical form and/or the comprised effective refractive index/indices which favors the guiding of light, in particular due to total internal reflection, into a predefined direction. One example is an optical fiber and/or a light guiding structure in the form of a waveguide, for example, a slab. Preferably, the light guiding structure is configured to feature a large acceptance angle of guided light. The skilled person knows how such a light guiding structure can be realized. With the light guiding structure, a distance from the lateral surface to the sensor can be overcome without significant losses of light and the amount of light coupled onto the sensor can be increased surprisingly. Furthermore, with such a light guiding structure, the coupling feature, the detection opening and the detection surface of the sensor do not need to be situated on a straight line of sight.

In a further embodiment of the disclosure, the coupling feature comprises a microstructure configured for directing ambient light impinging on the microstructure onto the sensor.

A microstructure preferably is a structure featuring dimensions in the micrometer (μm) range. It can feature structures with dimension of 100 nanometers (nm) or larger, 1 μm or larger, 10 μm or larger, 100 μm or larger and/or 1000 μm or larger. A microstructure can be configured such that it has certain optical properties which favor the direction of light onto the sensor. Due to the small dimensions of the microstructure, there is a large configuration flexibility of the microstructure.

Furthermore, by combination of several microstructures, each featuring the desired functionality, these effects can be scaled up easily. There can, for example, be 2 microstructures or more, 5 microstructures or more, 10 microstructures or more, 20 microstructures or more, 30 microstructures or more, 40 microstructures or more, 50 microstructures or more, 100 microstructures or more, 500 microstructures or more, 1000 microstructures or more, 10 000 microstructures or more, 50 0000 microstructures or 100 000 microstructures or more. In particular, due to the small dimensions of the microstructure, it can have optical properties which make use of the wavelike nature of the light and can, for example, exploit the Huygens-Fresnel principle. A particular example of such a microstructure would be diffractive structure, for example, a grating or a reflective diffractive structure.

A skilled person knows how to fabric such microstructures.

In a further embodiment of the disclosure, the microstructure comprises at least one micromirror. A micromirror preferably is a mirror having the properties of a microstructure as mentioned above. Preferably, more than one micromirror is comprised. There can, for example, be 2 micromirrors or more, 5 micromirrors or more, 10 micromirrors or more, 20 micromirrors or more, 30 micromirrors or more, 40 micromirrors or more, 50 micromirrors or more, 100 micromirrors or more, 500 micromirrors or more, 1000 micromirrors or more, 10 000 micromirrors or more, 50 0000 micromirrors or 100 000 micromirrors or more. At the same time, each micromirror can be oriented differently, such that an arrangement of micromirrors over a macroscopic (for example, dimensions in the millimeter to centimeter range) area or volume can be created wherein each mirror is particularly well oriented in order to couple a maximum amount of light onto the sensor.

A structure comprising several micromirrors could particularly comprise at least one first micromirror which is configured to direct light from different directions onto at least one second micromirror configured to direct light coming from the first micromirror onto the sensor. The first micromirror could, for example, be a parabolic mirror.

The micromirror(s) could be, for example, comprised in the lateral surface of the display element or at some appropriate location within the display element.

With this micromirror(s), the amount of light coupled onto the sensor can be increased.

In an embodiment, the microstructure includes a micro-lens or an array of micro-lenses.

In a further embodiment of the disclosure, the head-mounted-display is selected from the group comprising data glasses, augmented reality glasses and/or smart glasses. The head-mounted-display can in particular be in the form of wearable smart glasses or smart eyeglasses.

In a further embodiment of the disclosure, the fixation component comprises a spectacle frame.

In a further embodiment of the disclosure, the display element comprises at least one lens, wherein the lateral surface comprises a lens edge.

### BRIEF DESCRIPTION OF THE DRAWINGS

The invention will now be described with reference to the drawings wherein:

FIG. 1 shows a head-mounted-display in the form of data glasses, augmented reality glasses and/or smart glasses with possible locations of the at least one sensor.

FIG. 2 shows an example of an ambient light beam (or ray), impinging on the lens edge of the data glasses.

FIG. 3 shows how guided light from different lens edge locations comprising a coupling feature is directed onto the sensor.

FIG. 4 shows that different possible directions of ambient light hitting the lens edge.

FIG. 5 shows an embodiment, where the coupling feature is comprised a marking.

### DESCRIPTION OF THE PREFERRED EMBODIMENTS

FIG. 1 shows a head-mounted-display 1 in the form of data glasses, augmented reality glasses and/or smart glasses. These glasses have the appearance of regular glasses. The fixation component 5 is a spectacle frame in this embodiment. The spectacle frame 5 comprises at least one sensor configured for the detection of ambient light 3. Exemplary locations of the sensor 3 within the spectacle frame 5 are shown in this figure. Of course, if there is more than one sensor 3, it can be at least at two of the three proposed locations or also at other locations. The display element 7 shown in FIG. 1 is an areal display element comprising a lateral surface represented by two lenses. The lateral surface comprises thus a lens edge. In the shown embodiment, the sensor 3 locations are at a region where the spectacle frame 5 is in contact with the lens 7 at its edges.

The symbolized locations of the sensor 3 shown in FIG. 1 are for illustration purposes only. The sensor 3 is preferably not localized at the external surface of the spectacle frame 5 and is thus not really visible in the shown manner. Rather, the sensor lies inside the spectacle frame 5 and is optically accessible only via the display element 7 and/or openings at the contact surface of the spectacle frame 5 with the display element 7 in a region where the sensor 3 is located.

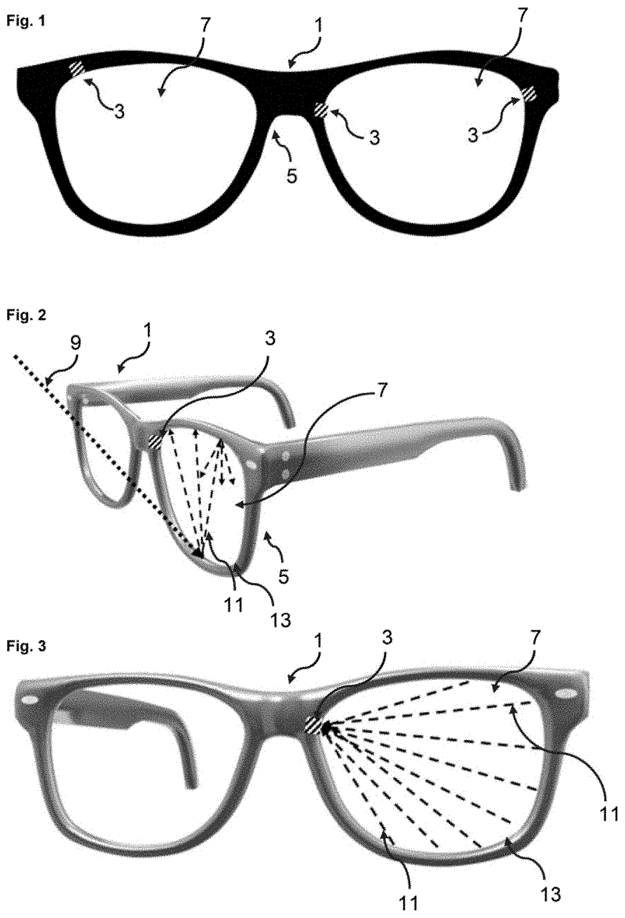

FIG. 2 shows an example of an ambient light beam 9 (or ray), impinging on the lens edge 13 of the data glasses. Light hitting the lens edge 13 is reflected from it in various directions. Some of the reflected light is guided in the display element 7 by internal reflection. These internally guided light beams are marked by reference sign 11 in FIG. 2. The shown reflected and guided beams 11 are actually reflected in a diffused manner, as opposed to a specular reflection. This can be seen by the various directions the ambient light beam 9 coming from a particular direction is reflected and guided 11. A specular reflection would be in a particular direction, where the absolute value of the angle at which the light is reflected at a surface equals the absolute value of the angle at which light beam 9 is incident on the surface. The shown diffusion has the advantage that all light incident on the lens edge 13 and guided 11 in the display element 7 are more evenly distributed within the display element and can thus reach the sensor 3 from different locations of the lens edge 13. For light which is reflected in a specular manner to reach the sensor 3, it has to be reflected in a particular angle with respect to a particular position on the lens edge. A lens edge 13 configured for a diffusion of the light incident on the lens edge 13 can, for example, be realized with a matt lens edge 13.

FIG. 3 shows how guided light 11 from different lens edge locations 13 is directed onto the sensor 3. The lens edge 13 shown in FIG. 3 is a coupling feature. There can be several realizations for the lens edge 13 to function as a coupling feature. It could be, for example, that the lens edge 13 comprises a matt surface. As explained above in the context of FIG. 2, such a matt surface diffuses ambient light impinging on it in different directions. The guided light beams 11 shown in FIG. 3 are those, which are diffused such that they are directed onto the sensor 3. In an alternative embodiment of the lens edge 13 which comprises the coupling feature, the lens edge could comprise microstructures in form of micro-mirrors at different locations of the lens edge. The micro-mirrors are preferably configured for the direction of ambient light impinging on them into the sensor 3. In particular, they can be optimized for light coming from a certain direction, preferably a directions straight in the field of view of the user and/or more or less perpendicular to the lenses (the lenses are preferably not perfectly plane, therefore the expression more or less is used). The micro-mirrors can, for example, comprise a combination of a parabolic mirror optimized for a preferred direction of light and a mirror in the focal point of the parabolic mirror for directing the light onto the sensor 3. Alternatively, the mirror can be arranged in an oblique plane with respect to the direction of the light in a manner that light impinging from that direction onto the mirror is reflected onto the sensor 3.

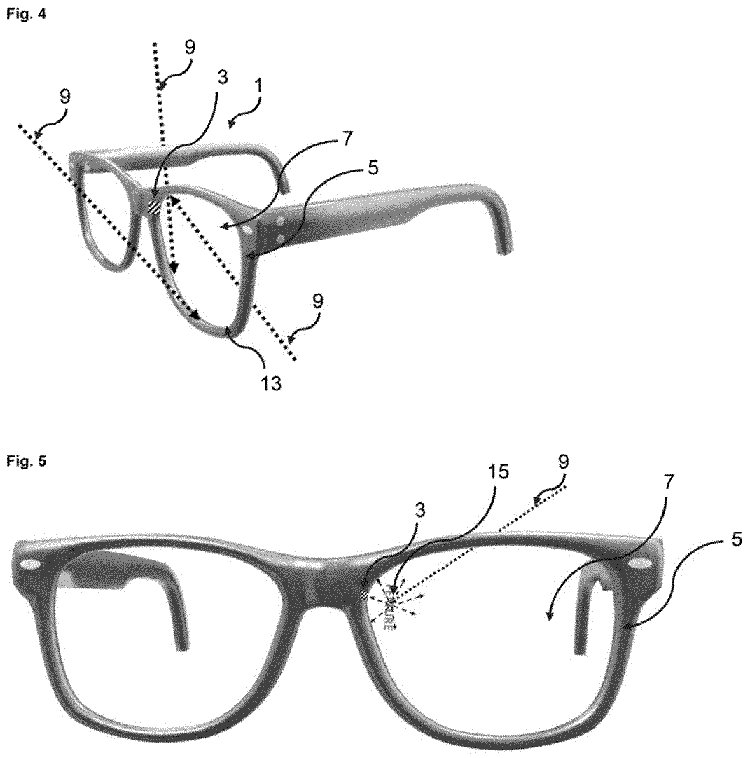

FIG. 4 shows that ambient light 9 can basically come from many different directions and that it can be preferred that a coupling feature, for example, in the lens edge 13, is optimized for light coming from different directions, for example, by comprising a diffusive structure, which diffuses and couples the light over a broad range of directions into the lens and, for matching directions, onto the sensor 3.

FIG. 5 shows an embodiment, where the coupling feature is comprised in a marking 15, in particular a logo, which itself is comprised in the display element 7. In the embodiment shown, the coupling feature is a marking 15 with a diffusive structure which diffuses ambient light, represented here by a beam 9, which impinges onto the marking 15, in different directions, thereby, diffusing a sufficient share of the ambient light (which in reality comes also from many other directions), onto the sensor 3. Preferably, the marking 15 is small enough and/or transparent in a diffusive manner such that the field of view of the user is not significantly impaired.

It is understood that the foregoing description is that of the preferred embodiments of the invention and that various changes and modifications may be made thereto without departing from the spirit and scope of the invention as defined in the appended claims.

### REFERENCE SIGNS

1 Head mounted display (data glasses)
3 Sensor (ALS)
5 Fixation component (Spectacle frame)
7 Transparent display element
9 Ambient light beam
11 Light beams guided inside the display element
13 Lens edge
15 Marking/logo

What is claimed is:

1. A head-mounted display comprising:
a fixation component configured to at least temporarily fix the head-mounted display to a head of a user;
a generally transparent display element configured to overlay a visual data output with an environment in a field of view of the user;
a sensor comprised in the fixation component and configured to detect ambient light; and,
said generally transparent display element including a coupling feature configured to direct ambient light impinging on the coupling feature onto the sensor.

2. The head-mounted display of claim 1, wherein the ambient light directed onto said sensor is guided in the display element.

3. The head-mounted display of claim 1, wherein said coupling feature is configured to direct ambient light impinging on said coupling feature onto said sensor by at least one of diffusion, reflection, specular reflection, refraction, and diffraction.

4. The head-mounted display of claim 1, wherein said display element is an areal display element having a lateral surface.

5. The head-mounted display of claim 1, wherein said display element includes a marking, wherein the coupling feature is comprised in the marking.

6. The head-mounted display of claim 5, wherein said marking includes a logo.

7. The head-mounted display of claim 5, wherein said display element is an areal display element having a lateral surface; and, said marking is comprised on at least one areal surface of said areal display element.

8. The head-mounted display of claim 4, wherein said coupling feature is comprised in said lateral surface.

9. The head-mounted display of claim 8, wherein said lateral surface features a matt surface.

10. The head-mounted display of claim 4, wherein said fixation component defines a detection opening at a contact surface of said fixation component with said lateral surface of said display element configured to enable an optical connection between said coupling feature and said sensor.

11. The head-mounted display of claim 1, wherein said fixation component has a bright surface.

12. The head-mounted display of claim 10, wherein said detection opening includes a light guiding structure configured for guiding light from said lateral surface to said sensor.

13. The head-mounted display of claim 1, wherein said coupling feature includes a microstructure configured to direct ambient light impinging on said microstructure onto said sensor.

14. The head-mounted display of claim 13, wherein said microstructure includes at least one micromirror.

15. The head-mounted display of claim 1, wherein the head-mounted-display is at least one of data glasses, augmented reality glasses, and smart glasses.

16. The head-mounted display of claim 15, wherein said fixation component includes a spectacle frame.

17. The head-mounted display of claim 15, wherein said display element is an areal display element having a lateral surface; and, said display element includes at least one lens, wherein said lateral surface includes a lens edge.

18. The head-mounted display of claim 11, wherein said bright surface is a white surface.

19. The head-mounted display of claim 11, wherein said fixation component has a bright surface at a region of said contact surface with said lateral surface of said display element.

20. The head-mounted display of claim 1, wherein the ambient light directed onto said sensor is guided in the display element due to internal reflection.
